(19) United States
(12) Patent Application Publication
(10) Pub. No.: US 2024/0338893 A1
(43) Pub. Date: Oct. 10, 2024

(54) FACE RELIGHTING OF AVATARS WITH HIGH-QUALITY SCAN AND MOBILE CAPTURE

(71) Applicant: Meta Platforms Technologies, LLC, Menlo Park, CA (US)

(72) Inventors: Kai Li, Fremont, CA (US); Peihong Guo, Santa Clara, CA (US); Christian Haene, Berkeley, CA (US); Jean-Charles Bazin, Sunnyvale, CA (US); Hai Phan, Foster City, CA (US)

(21) Appl. No.: 18/628,476

(22) Filed: Apr. 5, 2024

Related U.S. Application Data
(60) Provisional application No. 63/457,961, filed on Apr. 7, 2023.

(51) Int. Cl. G06T 17/20; G06T 7/40; G06T 7/60; G06T 7/70; G06V 10/141; G06V 10/60; H04N 13/351

(52) U.S. Cl. CPC G06T 17/20; G06T 7/40; G06T 7/60; G06T 7/70; G06V 10/141; G06V 10/60; H04N 13/351

(57) ABSTRACT

A system of the subject technology includes a mobile device operable to generate a mobile capture of a subject and multiple cameras to provide a multi-view scan of the subject under a uniform illumination. The system further includes a pipeline to perform several processes using the mobile capture and the multi-view scan to generate a relightable avatar. The mobile capture includes a video captured while the subject is moved relative to a light source.

### CROSS-REFERENCE TO RELATED APPLICATIONS

The present disclosure is related and claims priority under 35 USC § 119 (e) to U.S. Provisional Application No. 63/457,961, entitled “FACE RELIGHTING OF AVATARS WITH HIGH-QUALITY SCAN AND MOBILE CAPTURE,” filed on Apr. 7, 2023, the contents of which are herein incorporated by reference, in their entirety, for all purposes.

### BACKGROUND

### Technical Field

The present disclosure is related generally to the field of generating three-dimensional computer models of subjects in a video capture. More specifically, the present disclosure is related to generating relightable three-dimensional computer models of human faces for use in virtual reality, augmented reality, and mixed reality (VR/AR/MR) applications.

### Related Art

Animatable photorealistic digital humans are a key component for enabling social telepresence, with the potential to open a new way for people to connect while unconstrained to space and time. Relighting an image (e.g., an image of the face of a subject) allows reconstructing an image by artificially modifying the lighting condition and/or parameters on the image. For example, the source of light can be moved up, down, left or right, the direction of the illumination can be changed and parameters of the lighting including the color and intensity of the lighting can be altered. A majority of the relighting applications rely on the LightStage dataset, where the shape and material are captured under synchronized cameras and the light from multiple light sources, including from some recent papers on single image relighting methods. These methods are limited in use for the real cases, as the personalized reflectance is unknown and building a system with lighting variations is cumbersome. The reconstructed mesh from the multi-view scan (MVS) system has good accuracy but is captured in perfect uniform lighting. If a three-dimensional (3D) face-reconstruction model is trained using this uniform lighting, the neural networks might not generalize well to real indoor images.

The ability to adjust lighting conditions for a given three-dimensional computer model is highly desirable to immerse an avatar in a virtual scene of choice. Typically, relightable models are trained under multiple lighting configurations, which is a slow and costly process, and results in computationally costly procedures. Other approaches have opted for simplified feedback, using mobile captures of single users. While these models tend to have a low computational overhead and are quick to develop, they generally lack the desirable quality in a competitive market for immersive reality (IR) applications.

### SUMMARY

An aspect of the subject technology is directed to a system including a mobile device that is operable to generate a mobile capture of a subject and multiple cameras to provide a multi-view scan of the subject under a uniform illumination. The system further includes a pipeline to perform several processes using the mobile capture and the multi-view scan to generate a relightable avatar. The mobile capture includes a video captured while the subject is moved relative to a light source.

Another aspect of the disclosure is related to a method including retrieving multiple stage images including several views of a subject and retrieving multiple self-images of the subject by using a mobile device while the subject is being moved with respect to a point light source. The method further includes generating a 3D mesh of a head of the subject based on the stage images.

Yet another aspect of the disclosure is related to a method including retrieving multiple images of a subject from several view directions and forming multiple synthetic views of the subject for each view direction. The method further includes training a model with the multiple images of the subject and the multiple synthetic views of the subject.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram illustrating an example of an architecture for use of a VR headset running an immersive application, according to some aspects of the subject technology.

FIG. 2 is a schematic diagram illustrating an example of a pipeline in the process of generating a relightable avatar, according to some aspects of the subject technology.

FIG. 3 is a schematic diagram illustrating an example of an architecture of a relightable avatar model, according to some aspects of the subject technology.

FIG. 4 is a schematic diagram illustrating an example of images from mobile capture videos for use as input to generate a relightable avatar model, according to some aspects of the subject technology.

FIG. 5 is a schematic diagram illustrating an example of a texture map and a three-dimensional mesh of a subject face obtained from a multi-camera setup, according to some aspects of the subject technology.

FIG. 6 is a schematic diagram illustrating an example of a head pose estimation process to generate a relightable avatar model, according to some aspects of the subject technology.

FIG. 7 is a schematic diagram illustrating an example of a lighting estimation process to render a neutral representation for a relightable avatar model, according to some aspects of the subject technology.

FIGS. 8A and 8B are schematic diagrams illustrating examples of an irradiance map and a captured scene to determine an illumination direction, according to some aspects of the subject technology.

FIG. 9 is a schematic diagram illustrating an example of a light source intensity verification process in a relightable avatar model, according to some aspects of the subject technology.

FIG. 10 is a schematic diagram illustrating an example of an illumination direction verification process in a relightable avatar model, according to some aspects of the subject technology.

FIGS. 11A, 11B and 11C are schematic diagrams illustrating an example of settings of environment colors for a relightable avatar model, according to some aspects of the subject technology.

FIG. 12 is a schematic diagram illustrating an example of a relightable avatar rendered from a mobile phone video capture, according to some aspects of the subject technology.

FIG. 13 is a flow diagram illustrating a method for providing relightable avatars to immersive reality (IR) applications for headset users.

FIG. 14 is a flow diagram illustrating an example method for training a relightable avatar model for use in IR applications, according to some aspects of the subject technology.

In the figures, elements having the same or similar reference numerals are associated with the same or similar attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure. Embodiments as disclosed herein will be described with the description of the attached figures.

According to some aspects of the subject technology, without building a system with lighting variations, another mobile capture with an existing high-quality MVS scan system is leveraged to achieve the relighted dataset. This is done by augmenting the MVS data under uniform lighting. The disclosed technique further captures indoor mobile video under a point light source to solve for the person-specific reflectance.

Photorealistic avatars are becoming a trend for IR applications. One of the challenges presented is the accurate immersion of the photorealistic avatar in an arbitrary illumination setting, preserving high fidelity with a specific human face. Both the geometry and the texture of a human face is seamlessly reproduced under several illumination conditions. Current techniques tend to invest excessive time in training a model for relighting an avatar by using large numbers of image captures under multiple lighting configurations. As a result, the training process can be very long, given the large number of input configurations adopted. As a result, the model itself tends to exhaust the computational capability of typical systems used in IR applications. On the other hand, some approaches use a single scan collected by a mobile device user while moving relative to a given light source (e.g., a lamp, the sun, a candle, and the like). While models generated with this quick input tend to be simple and use low computational overhead, however, these models tend to suffer from quality issues and artifacts.

Typically, relighting avatar models rely on multi-view stage collected data, where the shape and material are captured under synchronized cameras and lights. However, these methods are limited in the real case, as the personalized reflectance is unknown, and building a system with lighting variations is cumbersome. The reconstructed mesh from the MVS system has good accuracy but is captured in uniform lighting. Neural networks for a 3D face reconstruction model trained under uniform lighting might not generalize well to real indoor images.

To resolve the above problems arising in the field of photo-realistic representations for IR applications, for relighting avatars according to a synthetic reality environment, the disclosed method uses an input from a multiple-camera collection session of a subject under uniform illumination of a neutral gesture. This is complemented with a mobile video scan of the same subject rotating with a fixed, neutral expression in a closed room environment including at least one light source. The method of the subject technology extracts fine texture and color information from the collection session and combines this information with the mobile video scan to feed multiple views of the subject with a variable light source orientation for training a neural network algorithm. The algorithm corrects for camera orientation and location, and environmental interferences (e.g., miscellaneous object shadows on the subject's face) in the video scan, to provide an accurate, yet simple to train algorithm for immersing a subject avatar in a synthetic environment.

The images of the subject are first captured with an MVS system under good, uniform lighting conditions. The MVS scan enables determining a good face geometry and albedo. The mobile scan videos are captured under a single point light source (e.g., a common floor lamp).

The relightable model is found by solving for lighting parameters and reflectance for the mobile capture in addition to identifying the head pose in the mobile videos. In some embodiments, lighting parameters include a light direction and distance, intensity, and a global environment map. For the global environment map, the system samples colors in a unit sphere for rendered pixels. Reflectance parameters include materials properties such as specular intensity and specular roughness. For camera poses and head pose, the neural network is trained to identify focal length (intrinsic camera parameter) and extrinsic camera parameters including head pose rotation, head pose translation, camera translation, global pixel scale, and updating directions of environment map and sun direction. Camera rotations are captured from mobile captures. The neural network training includes loss functions such as Landmarking loss (e.g., key point selection on collected images). In some embodiments, a loss function is the Euclidean distance between projected points and a corresponding point in a ground truth (e.g., collected) image. Some embodiments include a photometric loss as a two-dimensional norm between rendered images and original images, after binary masks eliminate background and hair textures, e.g., to select a face region only.

The face relighting technique of the subject technology can advantageously be used in various applications including AR, VR and IR devices to enhance device performance. Further, the application of the subject technology can improve existing models that tend to suffer from quality issues and artifacts, and provides an accurate, yet simple to train algorithm for immersing a subject avatar in a synthetic environment.

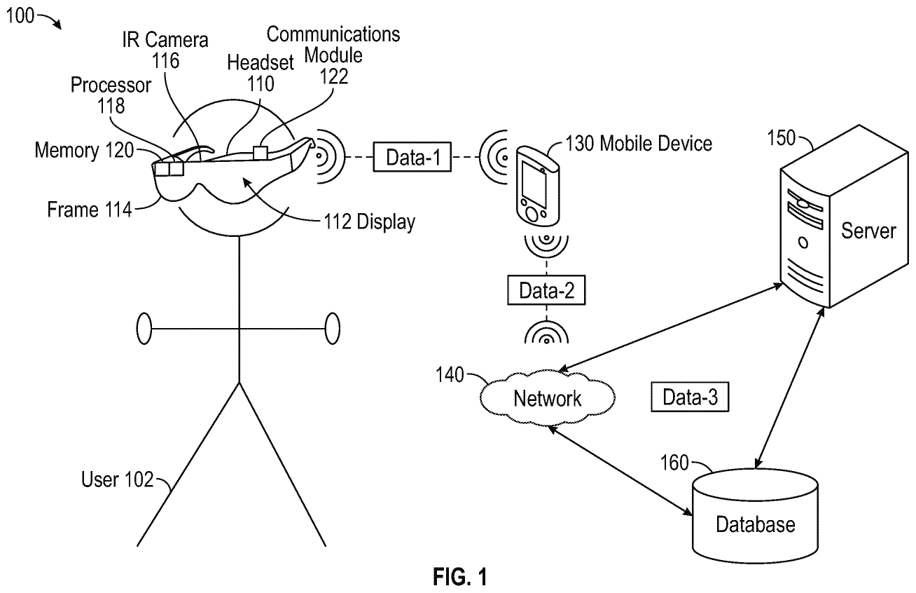

Now turning to the description of figures, FIG. 1 is a schematic diagram illustrating an example of an architecture 100 for use of a VR headset running an immersive application, according to some aspects of the subject technology. The VR headset 110 includes a display 112, a frame 114, an IR camera 116, a processor 118, a memory 120, and a communications module 122. The display 112 supports eyepieces, at least one of which includes a VR display. The memory circuit 120 stores instructions which, when executed by the processor circuit 118, cause the VR headset 110 to perform methods and processes of the subject technology, as disclosed herein. In some implementations, the memory circuit 120 includes the immersive application hosted by a remote server 150, which is coupled to a database 160 via a network 140. The communications module 122 enables the VR headset 110 to communicate Data-1 wirelessly with a mobile phone 130 (also referred to as a mobile device), via short-range communications (e.g., via Bluetooth, low energy-BLE-, Wi-Fi, near field communication—NFC—and the like). Further, the communications module 122 can enable communications with the remote server 150 or the database 160, via the network 140 (e.g., Data-2 and Data-3). In some implementations, the communication with the server 150 and the database 160 can take place with the help of the mobile phone 130. Accordingly, the VR headset 110 may exchange Data-1 with the mobile phone 130, and Data-2 and Data-3 may be communicated between the mobile phone 130, the server 150, the database 160 and the network 140.

In some embodiments, a user 102 of the VR headset 110 may collect a self-video scan while moving relative to a light source using the mobile phone 130. The mobile phone 130 then provides the self-scan of the user (Data-2) to the remote server 150. In some embodiments, the database 160 may include multiple images of the user 102 or a subject (Data-3) collected during a session in a multi-camera, multi-view stage. The remote server 150 may also use the stage images and the self-images from the user or the subject to generate a relightable avatar model of the user 102 or subject. The relightable avatar is then provided to the immersive application running in the VR headset 110 of the user 102 and other participants in an IR experience.

In some implementations, Data-1, Data-2, or Data-3 may include a relightable avatar of the user 102 of the VR headset 110 and/or other participants in the IR application. Accordingly, the VR headset 110 receives the relightable avatar and projects it on the display 112. In one or more implementations, the relightable avatar is generated within the VR headset 110 via the processor circuit 118 executing instructions stored in the memory circuit 120. The instructions may include steps in algorithms and processes as disclosed herein. In some embodiments, the VR headset 110 may provide the relightable avatar model (e.g., Data-1) to the mobile phone 130 or remote server 150 (Data-3), which in turn distributes the relightable avatar associated with the VR headset 110 with other participants in the IR application.

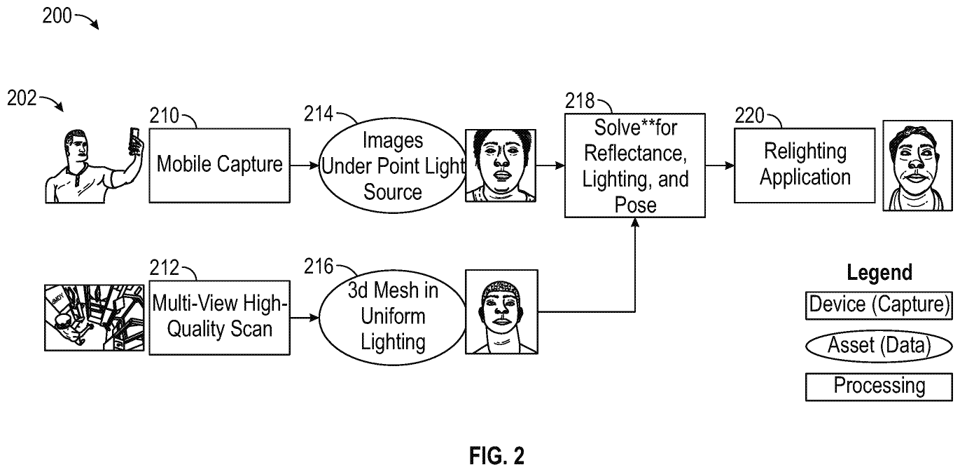

FIG. 2 is a schematic diagram illustrating an example of a pipeline 200 in the process of generating a relightable avatar, according to some aspects of the subject technology. The pipeline 200 can generate a relightable avatar that is accurate and can be implemented with reasonable computational capabilities. The pipeline 200 combines a mobile capture 210 of a user 202 and a multi-view, high-quality stage scan 212 (hereinafter, muti-view scan 212) of a subject. The mobile capture 210 generated by a mobile scan collects images 214 of the subject (e.g., the subject 202) while the subject moves relative to a point light source (e.g., a lamp, a flashlight, the sun), within a closed environment or outdoors. The multi-view scan 212 generates multiple images that are used by a processor to form a 3D mesh 216 of the subject's head under a (fixed) uniform lighting configuration. The multi-view scan 212 is performed simply by simultaneously taking a single picture by each of multiple cameras under a uniform lighting condition provided by several light sources and is significantly simpler than the existing MVS systems. Furthermore, the multi-view scan 212 can capture more details compared to the existing systems. For example, the multi-view scan 212 can capture a coarse geometry of the face (e.g., eyes, nose, mouth, etc.) and the hair of the subject.

Using the images 214 taken under the point light source from the mobile capture 210 and the stage inputs 216 (including 3D mesh with uniform lighting) from the high-quality stage scan 212, the pipeline 200, at a first processing stage 218, solves for parameters such as reflectance, lighting, and pose. In a second processing stage, the relighting application 220 generates a relightable model of the subject's head. The stage inputs 216 enable an accurate representation of the subject's head geometry and albedo (e.g., reflectance of each point in the user's head under uniform illumination conditions). The processing stage 218 may include using a neural network to define the parameters (reflectance, lighting, and pose). The relightable model is configured to estimate lighting and reflectance with few coupled parameters using the mobile capture 210 where different lighting conditions are tested by having the subject moving relative to a point light source.

The relightable model is obtained using a neural network approach to resolve pose, lighting, and reflectance attributes of synthetic views of the subject by finding appropriate loss functions to optimize such attributes based on the images collected (e.g., a ground-truth baseline). The disclosed technique is less complex as it does not need to solve for geometry and albedo as existing solutions do. The use of the multi-view scan 212 provides better accuracy and makes the estimation of lighting and reflectance easier. It is noted that the images of both the multi-view scan 212 and the mobile capture 210 are taken with the same facial expression (e.g., neutral) of the subject.

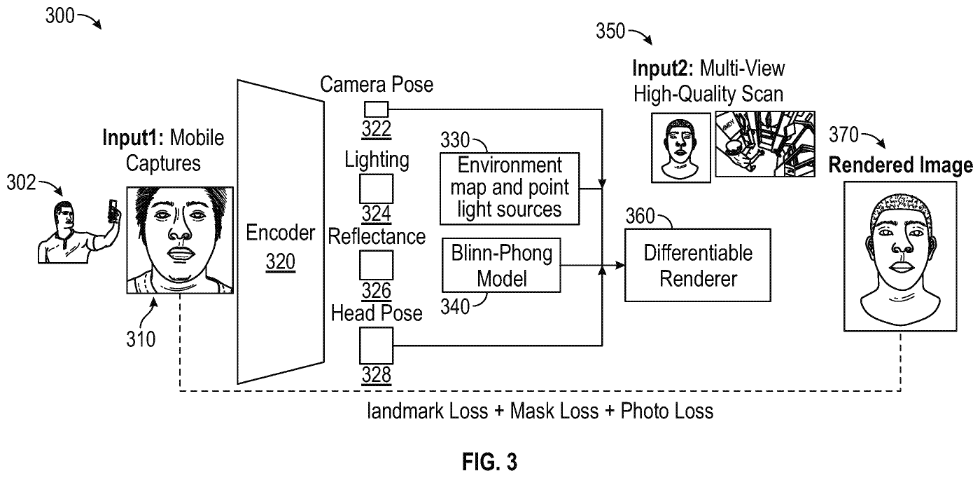

FIG. 3 is a schematic diagram illustrating an example of an architecture 300 of a relightable avatar model, according to some aspects of the subject technology. In the architecture 300, a first input 310 from a mobile capture of a subject moving relative to a fixed light source is received. A second input 350 includes multiple, multi-view, high-quality scans of the same subject. The second input 350 may be collected in a staged capture event at a specially designed studio that includes multiple cameras directed at the subject from multiple directions.

An encoder 320 (e.g., a deep learning neural network) uses the first input 310 and determines a camera pose 322 (e.g., a first distance between the camera and a fixed point) and lighting conditions 324 (e.g., light intensity, color, and geometry), which is processed to generate an environment map and point light sources 330. The encoder 320 further determines a reflectance 326 of the subject's face and measures a head pose 328 (e.g., second distance between the head and the fixed point) thereof. The reflectance 326 is the reaction of the face to the incident light and the surrounding environment and the reflectance for each pixel would be different for different faces. The reflectance 326 is used in a reflection model 340, for example, a Blinn-Phong model, which is an empirical model of the local illumination of points on a surface. A differentiable renderer 360 combines encoded inputs resulting from processing of the first input 310 (by encoder 320) with the second input 350 to provide a rendered image 370.

The differentiable renderer 360 uses loss functions wherein landmark points, mask profiles, and picture (e.g., color and texture) values are compared between the model and the ground truth images (e.g., from the first and second inputs).

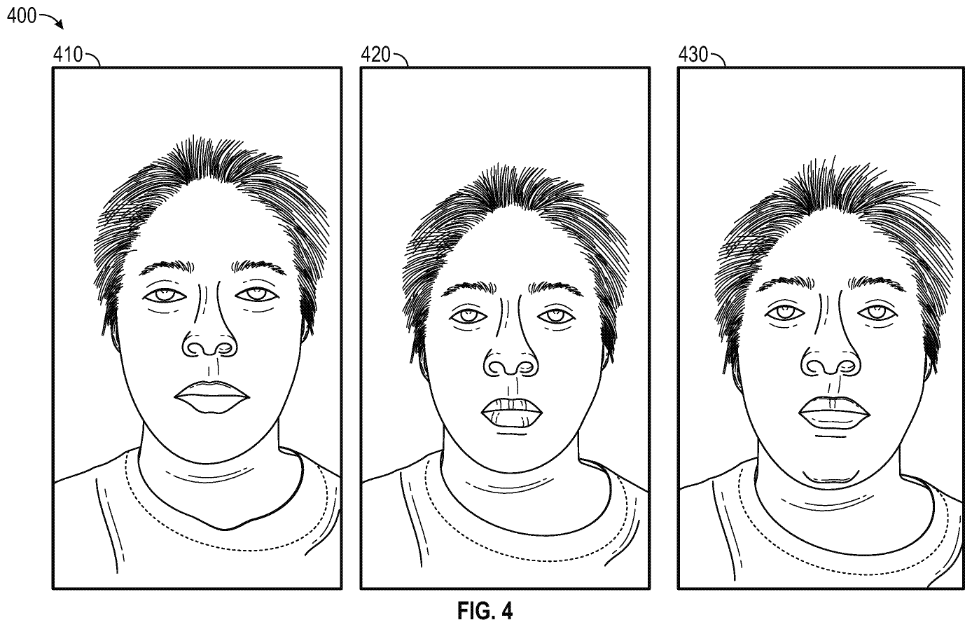

FIG. 4 is a schematic diagram illustrating example images 400 from mobile capture videos for use as input to generate a relightable avatar model, according to some aspects of the subject technology. The images 400 include images 410, 420 and 430, which are pictures of the subject taken at different illumination conditions. The image 410 shows a picture of the subject with the fixed light source to the right of the subject. The image 420 shows a picture of the subject where the user has rotated relative to the light source, which now forms a 45° to the front/right profile. The image 430 shows a picture of the subject where the light source is located to the left of the subject. In some implementations, each of the images 410, 420 and 430 are video images taken as the subject rotates.

Notice how the shades of the facial features have different format in each of the three illumination conditions shown in the images 410, 420 and 430. This format is formed by the head geometry, the position and distance of the light source relative to the subject (including the subject's head pose). Accordingly, the relightable avatar model is trained using the encoder 320 of FIG. 3 to learn the reflectance, color, and texture of each portion of the subject's face for the different illumination conditions and to predict these features for arbitrary illumination conditions.

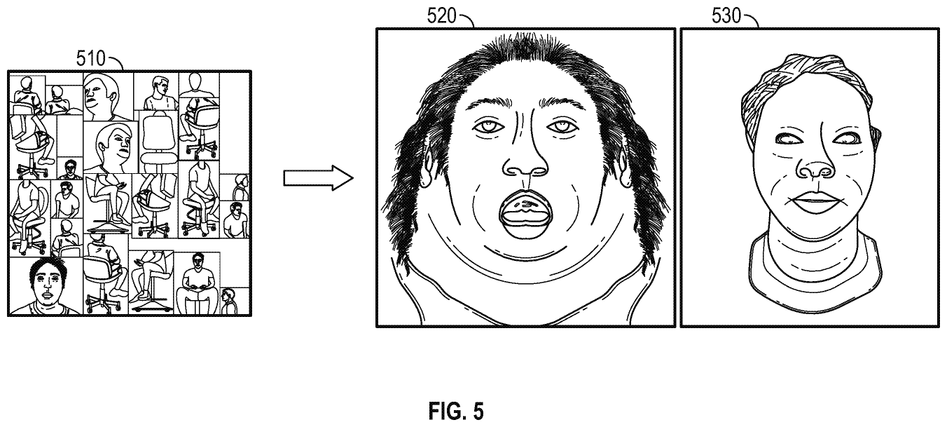

FIG. 5 is a schematic diagram illustrating an example of a texture map 520 and a 3D mesh 530 of a subject face obtained from a multi-camera setup, according to some aspects of the subject technology. The images of the subject face obtained from the multi-camera setup 510 are used to capture stage images of the subject. The texture map 520 includes color and reflectance of each portion of the subject's face, and the 3D mesh 530 accurately reflects the geometry of the face. Overlaying the texture map 520 on the 3D mesh 530 results in the rendered image, which has a neutral gesture of the subject under uniform illumination conditions, which are the illumination conditions used in the multi-camera stage capture.

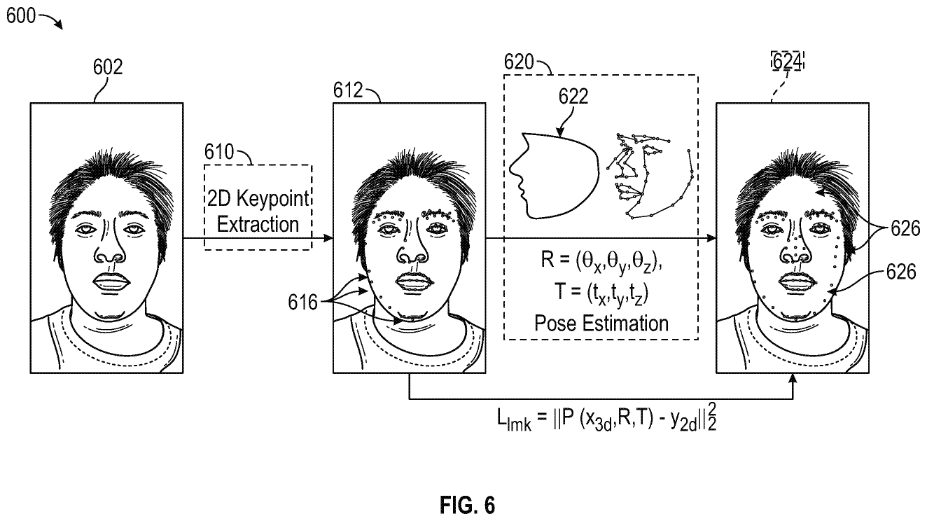

FIG. 6 is a schematic diagram illustrating an example of a head pose-estimation process 600 to generate a relightable avatar model, according to some aspects of the subject technology. In some implementations, the head pose-estimation process 600 includes a first process 610 and a second process 620. The first process 610 is a 2D key-point extraction stage that can identify and select a number of key points 616 on the subject's face 612 based on the 2D input image 602. The second process 620 selects additional key points 626 similar to the key points 616 from a 3D mesh 622 as shown on the image 624 with projected key points 626. A neural network model is trained to determine a pose estimation (P(x_{3d},R,T) based on a rotation triad R(θₓ, θ_{y}, θ_{z}) and a translation vector T(tₓ, t_{y}, t_{z}).

A landmark loss function Lₗₘₖ estimates the difference in position between the key points 626 in the 3D mesh and the corresponding key points 616 in the 2D input image (ground truth). The R and T parameters are adjusted to minimize the landmark loss to obtain the head pose. The landmark loss function Lₗₘₖ is given as:

$${L}_{lmk} = {‖ P ( {x}_{3 d} , R , T ) - {y}_{2 d} ‖}_{2}^{2} \qquad ( 1 )$$

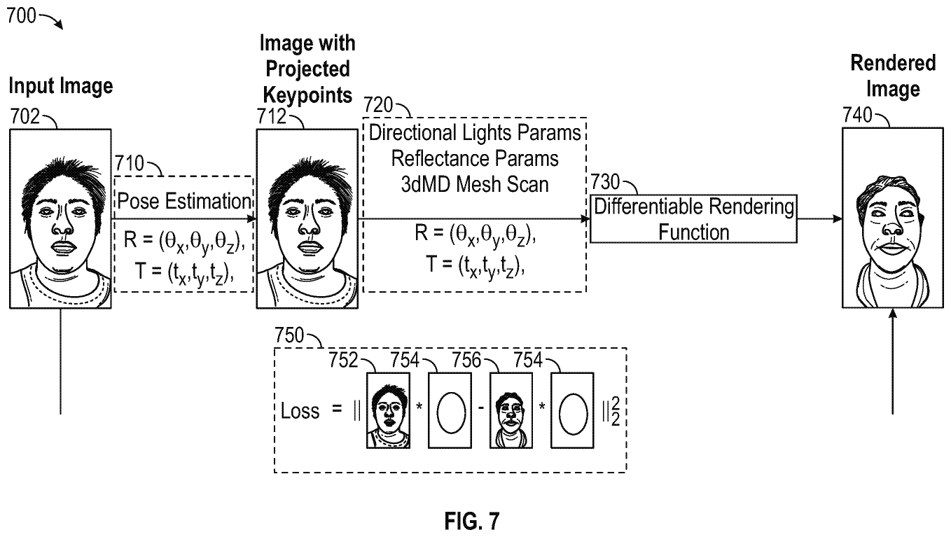

FIG. 7 is a schematic diagram illustrating an example of a lighting estimation process 700 to render a neutral representation 740 for a relightable avatar model, according to some aspects of the subject technology. The lighting estimation process 700 includes a pose-estimation stage 710 and a lighting-related process 720. The pose estimation stage 710 renders a head pose 702 with parameters R and T (cf. above). A lighting-related process 720 determines directional light parameters and reflectance parameter values based on the 3D mesh scan for each point in the subject's image 712 (which is a 2D projection of the subject's avatar). A differentiable rendering function 730 compares a color and intensity of each pixel in the rendered image with the input image (ground truth) using a loss function. Upon minimization of the loss function, an illumination direction and intensity are determined. Using a neural network (e.g., deep neural network), a relightable model is trained to render an image of the subject having a selected pose and illumination from a selected direction at a selected intensity, and with a selected source color or spectrum. The loss function 750 is defined as:

$$Loss = {‖ I ( x , y ) * M ( x , y ) - R ( x , y ) * M ( x , y ) ‖}_{2}^{2} \qquad ( 2 )$$

where M(x,y) represents the mask 754 and I(x,y) and R(x,y) represent the input image 752 and the rendered image 756, respectively.

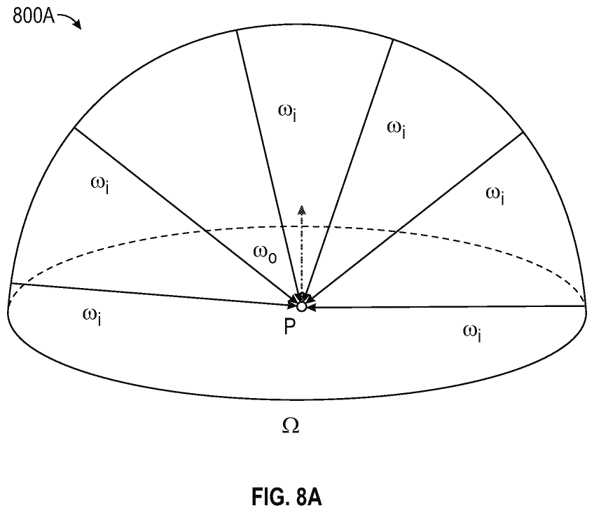

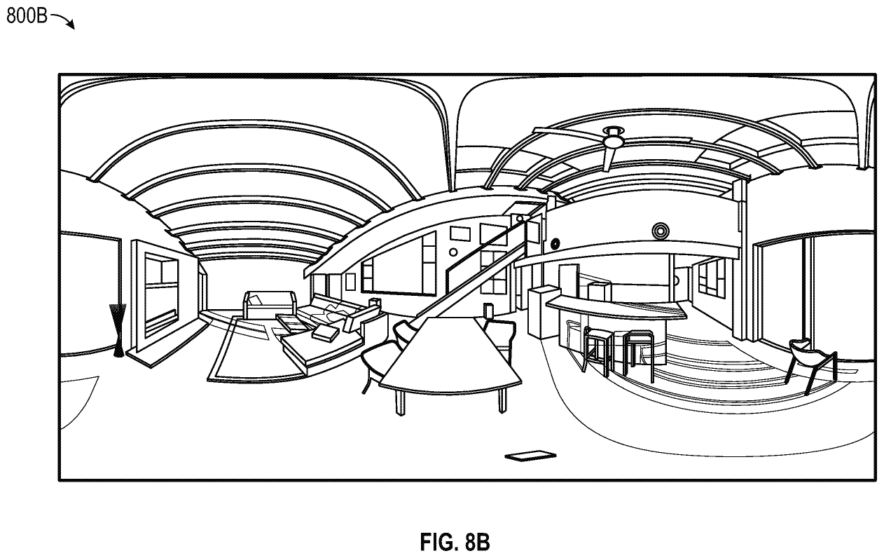

FIGS. 8A and 8B are schematic diagrams illustrating examples of an irradiance map 800A and a captured scene 800B to determine an illumination direction, according to some aspects of the subject technology. The irradiance map 800A illustrates different illumination directions used as inputs to a loss function (cf. Eq. 2). In some implementations, the illumination direction is determined from self-images captured with a mobile phone to generate a relightable avatar model.

The captured scene 800B depicts an environment captured to sample an environment color map from images captured with a mobile phone. In some embodiments, an incoming illumination vector from the irradiance map 800A is selected to match the scene radiance shown in the captured scene 800B.

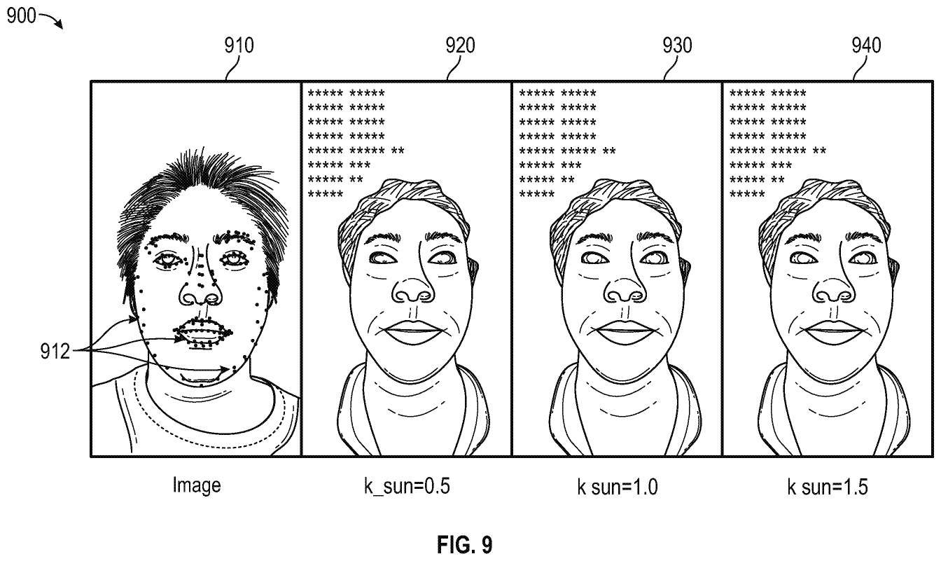

FIG. 9 is a schematic diagram illustrating an example of a light source intensity verification process in a relightable avatar model, according to some aspects of the subject technology. The input image 910 shows selected key points 912 for estimating a loss function. The avatar models are relighted by using the irradiance of the sun as a model, with different degrees of intensity increasing by proportional amounts from left to right. For example, the sun intensity levels for the rendered images 920, 930 and 940 are 0.5, 1.0 and 1.5, respectively. The intensity level that minimizes the loss function for the identified key points is then selected. Accordingly, the relightable model is trained to produce the corresponding avatar for a sun irradiance in the selected intensity level.

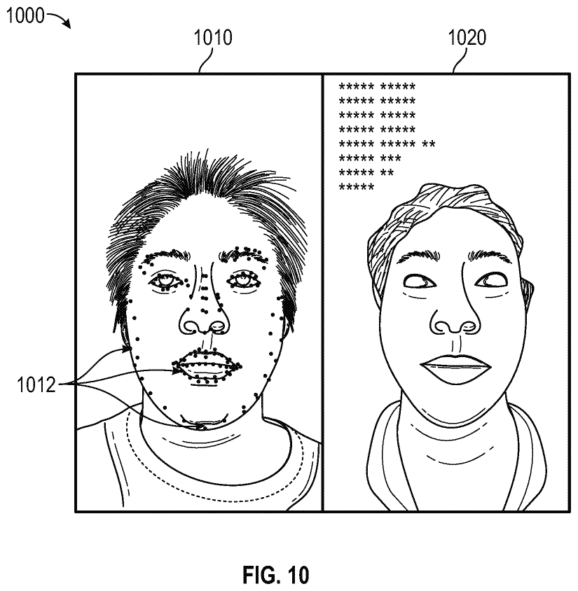

FIG. 10 is a schematic diagram illustrating an example of an illumination direction verification process 1000 in a relightable avatar model, according to some aspects of the subject technology. The illumination direction verification process 1000 includes moving a point source around the avatar's face until a loss function for selected key points 1012 in the collected image 1010 (ground truth) is minimized. The lighting shown in the image 1020 is from the point source that minimizes the loss function.

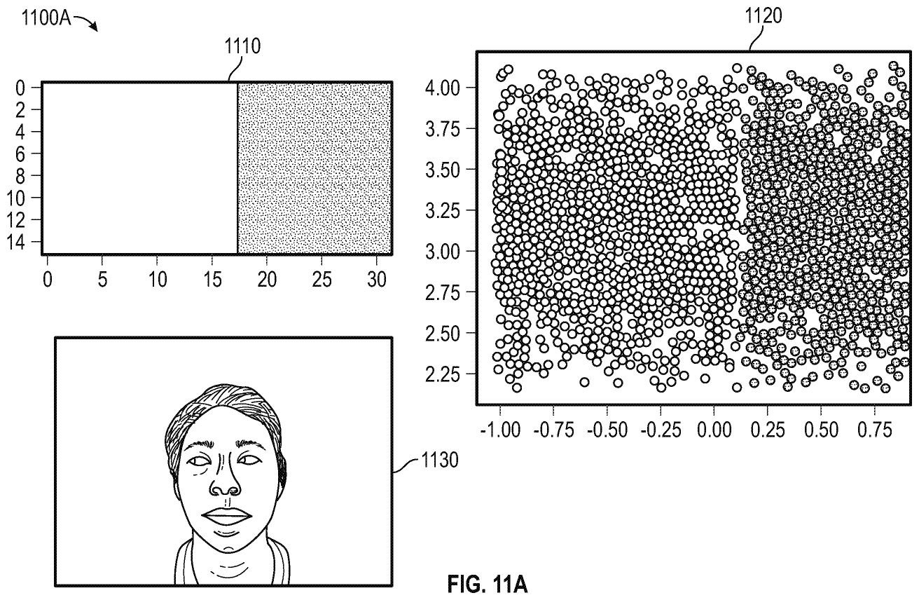

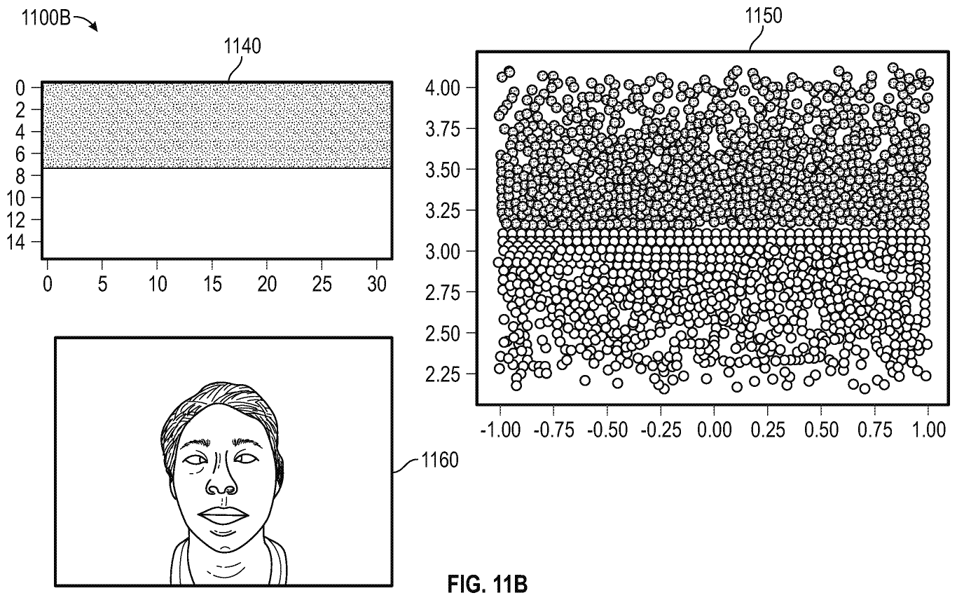

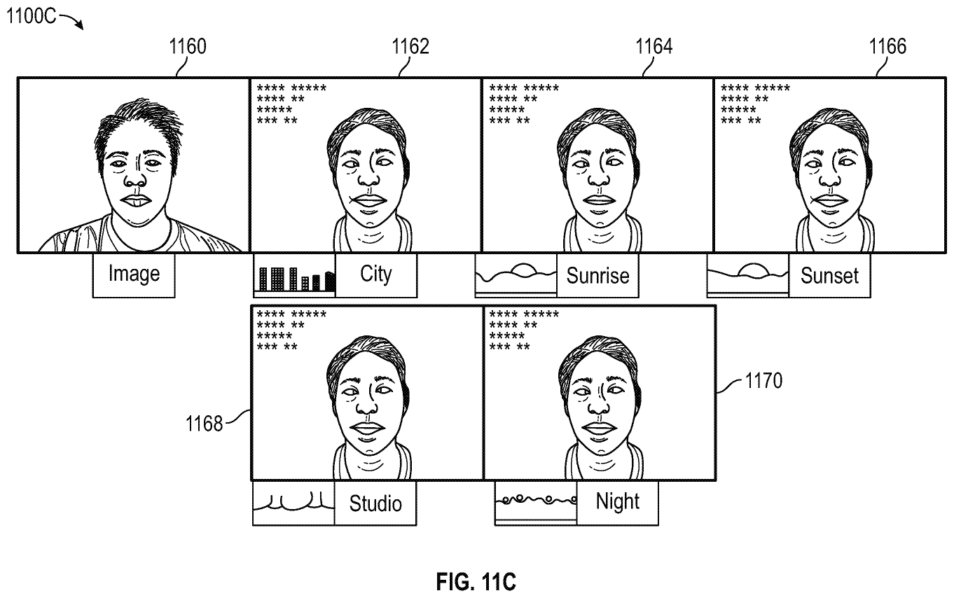

FIGS. 11A, 11B and 11C are schematic diagrams illustrating an example of processes for setting environment colors for a relightable avatar model, according to some aspects of the subject technology. The environment colors are a projection on the subject's face of the predominant colors in a scene laid out in front of the subject.

FIG. 11A illustrates an environment color map 1110, a 2D pixelated field 1120 and rendered image 1130. The environment color map 1110 is a simple panel with two colors (e.g., red and green) bisecting horizontally the plane of the subject's image. The scene colors can be displayed as the 2D pixelated field partitioned in areas where one color is predominant. The relightable model projects the 2D pixelated field 1120 onto a neutral texture map (e.g., a 2D, pixelated map) and overlays the colored texture map on the 3D mesh. The rendered image 1130 shown is a 2D projection of the resulting 3D mesh.

FIG. 11B illustrates an environment color map 1140, a 2D pixelated field 1150 and rendered image 1160. The environment color map 1140 is a simple panel with two colors (e.g., purple and yellow) bisecting horizontally the plane of the subject's image. The scene colors can be displayed as the 2D pixelated field partitioned in areas where one color is predominant. The relightable model projects the 2D pixelated field 1150 onto a neutral texture and overlays the colored texture map on the 3D mesh. The rendered image 1160 shown is a 2D projection of the resulting 3D mesh.

FIG. 11C illustrates more complex environment color maps 1100C that correspond to different scenes. Shown images 1162, 1164, 1166, 1168 and 1170 are relighted versions of the image 1160, and are associated with a city at noon, at sunrise, at sunset, inside a studio and at night looking through a window, respectively.

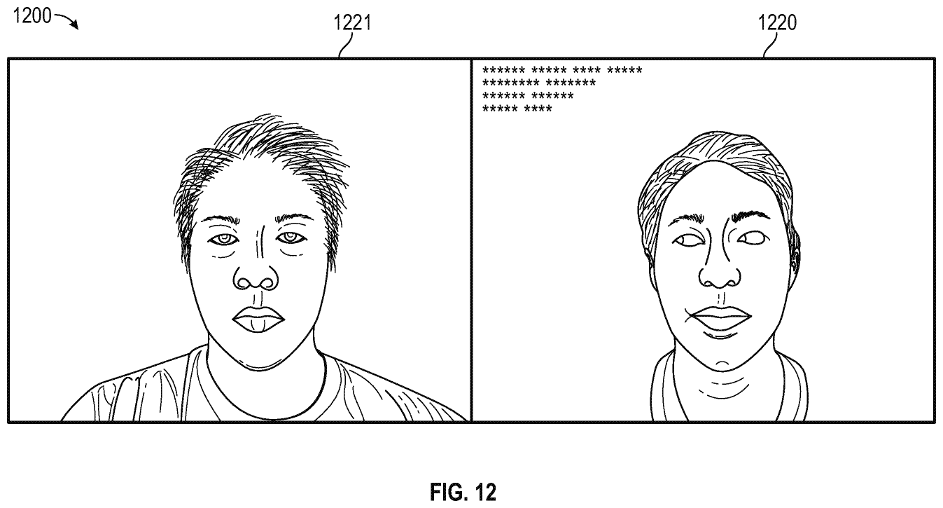

FIG. 12 is a schematic diagram 1200 illustrating an example of a relightable avatar 1220 rendered from a subject's image 1221 of a mobile phone video capture, according to some aspects of the subject technology.

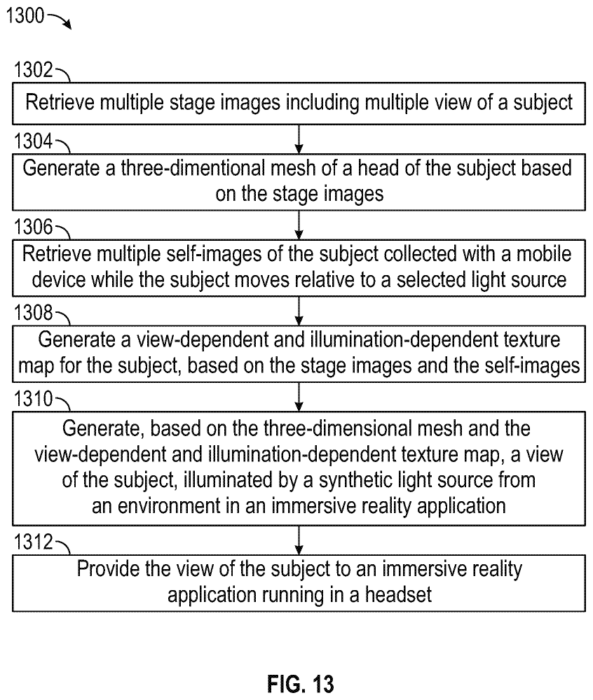

FIG. 13 is a flow diagram illustrating a method 1300 for providing relightable avatars to IR applications for headset users. In some embodiments, at least one step in the method 1300 may be executed by a processor circuit (e.g., 118 of FIG. 1) reading instructions from a memory circuit (e.g., 120 of FIG. 1). The processor circuit and the memory circuit may be in a VR headset (e.g., 110 of FIG. 1), a remote server (e.g., 150 of FIG. 1), a mobile phone (e.g., 130 of FIG. 1) and/or a database (e.g., 160 of FIG. 1), as disclosed herein. The VR headset, remote server, mobile phone and database may be communicatively coupled via a network (e.g., 140 of FIG. 1), by a communications module.

In some embodiments, methods consistent with the present disclosure may include at least one or more of the steps in the method 1300 performed in a different order, simultaneously, quasi-simultaneously, or overlapping in time.

Step 1302 includes retrieving multiple stage images including multiple views (e.g., 214 of FIG. 2) of a subject (e.g., 202 of FIG. 2).

Step 1304 includes generating a 3D mesh (e.g., 216 of FIG. 2) of a head of the subject based on the stage images.

Step 1306 includes retrieving multiple self-images (e.g., 210 of FIG. 2) of the subject collected with a mobile device (e.g., used by the subject 202 of FIG. 2) while the subject moves relative to a selected light source.

Step 1308 includes generating a view-dependent and illumination-dependent texture map (e.g., 520 of FIG. 5) for the subject, based on the stage images and the self-images.

Step 1310 includes generating, based on the 3D mesh and the view-dependent and illumination-dependent texture map, a view of the subject, illuminated by a synthetic light source from an environment in an IR application.

Step 1312 includes providing the view of the subject to the IR application, running in a headset.

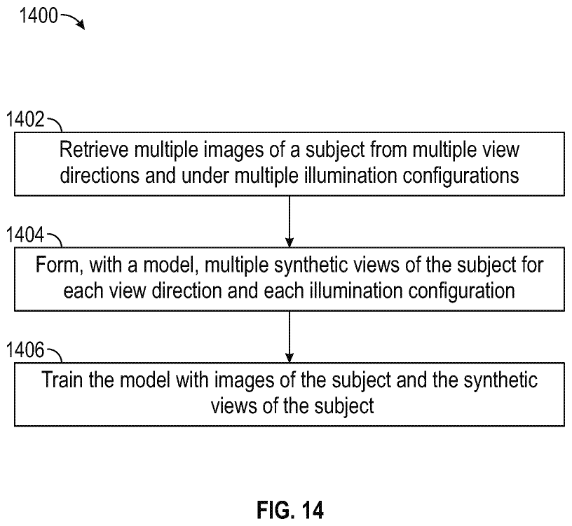

FIG. 14 is a flow diagram illustrating an example method 1400 for training a relightable avatar model for use in IR applications, according to some aspects of the subject technology. In some embodiments, at least one step in the method 1400 may be executed by a processor circuit (e.g., 118 of FIG. 1) reading instructions from a memory circuit (e.g., 120 of FIG. 1). The processor circuit and the memory circuit may be in a VR headset (e.g., 110 of FIG. 1), a remote server (e.g., 150 of FIG. 1), a mobile phone (e.g., 130 of FIG. 1) and/or a database (e.g., 160 of FIG. 1), as disclosed herein. The VR headset, remote server, mobile phone and database may be communicatively coupled via a network (e.g., 140 of FIG. 1), by a communications module.

In some embodiments, methods consistent with the present disclosure may include at least one or more of the steps in method 1400 performed in a different order, simultaneously, quasi-simultaneously, or overlapping in time.

Step 1402 includes retrieving multiple images of a subject from multiple view directions and under multiple illumination configurations (see FIGS. 9 and 11C).

Step 1404 includes forming, using a model (e.g., a neural network model), multiple synthetic views of the subject for each view direction and each illumination configuration.

Step 1406 includes training the model with the images of the subject and the synthetic views of the subject (e.g., images 900 of FIG. 9).

According to some aspects, the subject technology is directed to a system including a mobile device that is operable to generate a mobile capture of a subject and multiple cameras to provide a multi-view scan of the subject under a uniform illumination. The system further includes a pipeline to perform several processes using the mobile capture and the multi-view scan to generate a relightable avatar. The mobile capture includes a video captured while the subject is moved relative to a light source.

In some implementations, the multiple cameras are fixed around the subject, and the uniform illumination is provided by several light sources.

In one or more implementations, the multiple cameras are configured to simultaneously take images of the multi-view scan.

In some implementations, the images of the multi-view scan include a coarse geometry of a face including at least eyes, a nose and a mouth of the subject, and hairs of the subject.

In one or more implementations, the pipeline includes a first processing stage configured to determine at least a reflectance, a pose and lighting parameters based on the mobile capture and the multi-view scan.

In some implementations, the pipeline further includes a second processing stage configured to generate a relightable model of a head of the subject based on the reflectance, the pose and the lighting parameters.

In one or more implementations, the pipeline further includes a differentiable renderer configured to combine the reflectance, the pose and the lighting parameters with images of the multi-view scan to provide a rendered image.

In some implementations, the pose includes a camera pose and a head pose.

In one or more implementations, the camera pose includes a first distance between the mobile device and a fixed point. the head pose includes a second distance between the mobile device and the fixed point.

In some implementations, the light source includes a point light source.

Another aspect of the disclosure is related to a method including retrieving multiple stage images including several views of a subject and retrieving multiple self-images of the subject by using a mobile device while the subject is being moved with respect to a point light source. The method further includes generating a 3D mesh of a head of the subject based on the stage images.

In some implementations, the method further includes generating a texture map for the subject based on the stage images and the self-images.

In one or more implementations, the texture map comprises a view-dependent and illumination-dependent texture map.

In some implementations, the method further includes generating, based on the texture map and the 3D mesh, a view of the subject illuminated by a synthetic light source.

In one or more implementations, the synthetic light source is associated with an environment in an immerse reality (IR) application.

In some implementations, the method further includes providing the view of the subject to the IR application running on a headset.

Yet another aspect of the disclosure is related to a method including retrieving multiple images of a subject from several view directions and forming multiple synthetic views of the subject for each view direction. The method further includes training a model with the multiple images of the subject and the multiple synthetic views of the subject.

In one or more implementations, retrieving the multiple images of the subject is under several illumination configurations.

In some implementations, forming the plurality of synthetic views of the subject are further for each illumination configuration of the several illumination configurations.

In one or more implementations, the method further includes using a mobile device to capture at least some of the plurality of images of the subject from the plurality of view directions using a single point light source.

In some implementations, the method further includes using several cameras and a few light sources to provide a uniform illumination to capture at least some of the multiple images of the subject.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

Aspects of the subject matter described in this disclosure can be implemented to realize one or more of the following potential advantages. The described techniques may be implemented to support a range of benefits and significant advantages of the disclosed eye tracking system. It should be noted that the subject technology enables fabrication of a depth-sensing apparatus that is a fully solid-state device with small size, low power, and low cost.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A system, comprising:
a mobile device operable to generate a mobile capture of a subject;
a plurality of cameras configured to provide a multi-view scan of the subject under a uniform illumination; and
a pipeline configured to perform a plurality of processes using the mobile capture and the multi-view scan to generate a relightable avatar,
wherein the mobile capture includes a video captured while the subject is moved relative to a light source.

2. The system of claim 1, wherein the plurality of cameras are fixed around the subject, and the uniform illumination is provided by a plurality of light sources.

3. The system of claim 1, wherein the plurality of cameras are configured to simultaneously take images of the multi-view scan.

4. The system of claim 3, wherein the images of the multi-view scan comprise a coarse geometry of a face including at least eyes, a nose and a mouth of the subject, and hairs of the subject.

5. The system of claim 1, wherein the pipeline comprises a first processing stage configured to determine at least a reflectance, a pose and lighting parameters based on the mobile capture and the multi-view scan.

6. The system of claim 5, wherein the pipeline further comprises a second processing stage configured to generate a relightable model of a head of the subject based on the reflectance, the pose and the lighting parameters.

7. The system of claim 5, wherein the pipeline further comprises a differentiable renderer configured to combine the reflectance, the pose and the lighting parameters with images of the multi-view scan to provide a rendered image.

8. The system of claim 5, wherein the pose comprises a camera pose and a head pose.

9. The system of claim 8, wherein the camera pose comprises a first distance between the mobile device and a fixed point, and wherein the head pose comprises a second distance between the mobile device and the fixed point.

10. The system of claim 1, wherein the light source comprises a point light source.

11. A method comprising:
retrieving a plurality of stage images including a plurality of views of a subject;
retrieving a plurality of self-images of the subject by using a mobile device while the subject is being moved with respect to a point light source; and
generating a three-dimensional (3D) mesh of a head of the subject based on the stage images.

12. The method of claim 11, further comprising generating a texture map for the subject based on the stage images and the self-images.

13. The method of claim 12, wherein the texture map comprises a view-dependent and illumination-dependent texture map.

14. The method of claim 13, further comprising generating, based on the texture map and the 3D mesh, a view of the subject illuminated by a synthetic light source, and wherein the synthetic light source is associated with an environment in an immerse reality (IR) application.

15. The method of claim 14, further comprising providing the view of the subject to the IR application running on a headset.

16. A method comprising:
retrieving a plurality of images of a subject from a plurality of view directions;
forming a plurality of synthetic views of the subject for each view direction of the plurality of view directions; and
training a model with the plurality of images of the subject and the plurality of synthetic views of the subject.

17. The method of claim 16, wherein retrieving the plurality of images of the subject is under a plurality of illumination configurations.

18. The method of claim 17, wherein forming the plurality of synthetic views of the subject are further for each illumination configuration of the plurality of illumination configurations.

19. The method of claim 16, further comprising using a mobile device to capture at least some of the plurality of images of the subject from the plurality of view directions using a single point light source.

20. The method of claim 16, further comprising using a plurality of cameras and a plurality of light sources to provide a uniform illumination to capture at least some of the plurality of images of the subject.
